(19) United States
(12) Patent Application Publication
(10) Pub. No.: US 2017/0371603 A1
(43) Pub. Date: Dec. 28, 2017

(54) METHOD AND COMPUTER PROGRAM PRODUCT FOR GENERATING OUTPUT PRINT DATA FOR PRINTING MULTIPLE COPIES WITH AT LEAST ONE VARIABLE ELEMENT ON A PRINT SHEET

(71) Applicant: Océ Holding B.V., Venlo (NL)

(72) Inventor: Karl Michael Tischler, Neuburg/Donau (DE)

(73) Assignee: Océ Holding B.V., Venlo (NL)

(21) Appl. No.: 15/635,820

(22) Filed: Jun. 28, 2017

(30) Foreign Application Priority Data
Jun. 28, 2016 (DE) 102016111778.1

(51) Int. Cl. G06F 3/12; H04N 1/00

(52) U.S. Cl. CPC G06F 3/1243; G06F 3/1284; H04N 1/0044; G06F 3/1203; G06F 3/1256; H04N 2201/0082

(57) ABSTRACT

A method for generating output print data for printing multiple copies having at least one variable element onto a print sheet can include: providing a presentation of the print sheet in a workspace of a graphical user interface; determining a basic area in which at least one object is arranged for generation of the variable element; replicating and arranging the basic area having the at least one object, corresponding to a predetermined grid of the copies; and filling of the replicated objects to generate the variable elements with variable print data.

### CROSS REFERENCE TO RELATED APPLICATIONS

This patent application claims priority to German Patent Application No. 102016111778.1, filed Jun. 28, 2016, which is incorporated herein by reference in its entirety.

### BACKGROUND

The present disclosure is directed to printing systems, including methods and computer program products for generating output print data for printing multiple copies with at least one variable element on a print sheet.

Conventional, there is what is known as the “serial letter function” to furnish a document with variable data. It is used in common word processing tools (for example MS Word or OpenOffice etc.) to add in the variable contents upon creation of the document. Other software, for example Adobe Illustrator, Adobe InDesign or Adobe Photoshop, use plugins (for example XMPie, http://www.xmpie.com/vdp) for this, which for the most part are designed for a specific task and whose use is relatively inflexible. The software “Design & Print” from the company AVERY Zweckform is also relatively inflexible in application.

Although the latter software exhibits the common functions for insertion and editing of variable elements, only a fixed layout of label sheets may be selected from a predefined, company-specific catalog.

In a special case of the workflow of the PRISMAproduction system, an Adobe Illustrator plugin is used. However, its handling is complicated and elaborate and requires multiple work steps, especially given many copies to be printed on a print sheet. An expensive Adobe Illustrator license is necessary for this.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a flow diagram of a method to generate output print data for printing multiple copies with at least one variable element on a print sheet according to an exemplary embodiment of the present disclosure;

FIG. 2a illustrates a graphical user interface (GUI) having a workspace for the visualization of a presented print sheet having multiple copies arranged in a predetermined grid according to an exemplary embodiment of the present disclosure;

FIG. 2b illustrates an exemplary embodiment of the workspace of the graphical user interface according to FIG. 2a for the visualization of the determination of a basic area in an operation of the method according to FIG. 1;

FIG. 2c illustrates an exemplary embodiment of the workspace of the graphical user interface according to FIG. 2a for the visualization of the replication and arrangement of the basic area in an operation of the method according to FIG. 1; and

FIG. 3 illustrates an example of a print sheet having multiple lines of copies arranged in superposition to produce multiple folded boxes according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

It is the object of the present disclosure to specify a design for generating output print data for printing multiple copies with at least one variable element on a print sheet, which design enables a simple, efficient and precise provision of the print sheet with variable elements.

A simple, efficient and precise provision of the print sheet with variable elements is achieved via a method according to an exemplary embodiment described herein. For this, input print data is provided for the printing of multiple copies having at least one variable element. The input print data is processed to present the print sheet with the multiple copies. A presentation of the print sheet is provided in a workspace of a graphical user interface (GUI). The presented print sheet includes multiple copies arranged in a predetermined grid. A basic area is established in which at least one object is arranged for the generation of the variable element. The position of the object is established relative to the basic area. The basic area includes precisely one copy. The basic area with the at least one object is replicated and arranged according to the predetermined grid of copies. The output print data for printing the copies with the at least one variable element are generated in that the replicated objects for generation of the variable element are filled with variable print data. In an exemplary embodiment, the replication of the basic area with the at least one object takes place automatically. A complicated and elaborate distribution of variable elements to the copies of the print sheet may thereby be avoided. A simple, efficient and precise provision of the print sheet with variable elements is thus enabled.

It is advantageous if the replication of the basic area with the at least one object takes place with the aid of a repetition rule. In an exemplary embodiment, the repetition rule specifies an individual association of the replicated objects with the individual copies of the print sheet. A simple and efficient distribution of the objects to be filled with variable print data among the copies of the print sheet may thus be realized.

In an exemplary embodiment, it is also advantageous if, in the replication of the basic area with the at least one object, each basic region can be individually shifted and/or rotated so that this is respectively arranged according to the predetermined grid of the copies after the shifting and/or rotation. The objects to be filled with variable print data may thus be automatically arranged in a predetermined distribution. Alternatively or additionally, each basic area may be manually shifted and/or rotated after its replication in order to achieve a very flexible arrangement of the objects. The objects may hereby also be arranged in a distribution that deviates from the predetermined distribution.

An additional aspect of the present disclosure relates to a computer program product, comprising commands and data in coded form that—after the loading of the program data—induce a processor to execute the operations of the method according to exemplary embodiments of the present disclosure. The computer program product may be stored on a USB stick, a DVD, a CD or another transportable storage medium, or may be provided on a web server for download.

The computer program product according to one or more exemplary embodiments enables finalized print data to be supplemented afterwards. With the aid of said computer program product, it is possible in particular to import and process large-format, pre-produced and interleaved print sheets form files (for example PDF).

In the printing of packaging, the number of instances of a print product that are located on a print sheet, or the individual instances of a printed product that are printed on a continuous substrate material, are also designated as copies. In order to optimally use the space on the print sheet or on the continuous substrate material, and thereby to print cost-effectively, multiple identical or different copies—for example labels, posters, packaging, business cards etc.—are normally distributed on the available print sheet or continuous substrate material. In particular, multiple printed blanks are then generated from the print sheet or the continuous substrate material to produce folded boxes.

Those print sheets that are cut from belt-shaped material after printing may also be intended as print sheets.

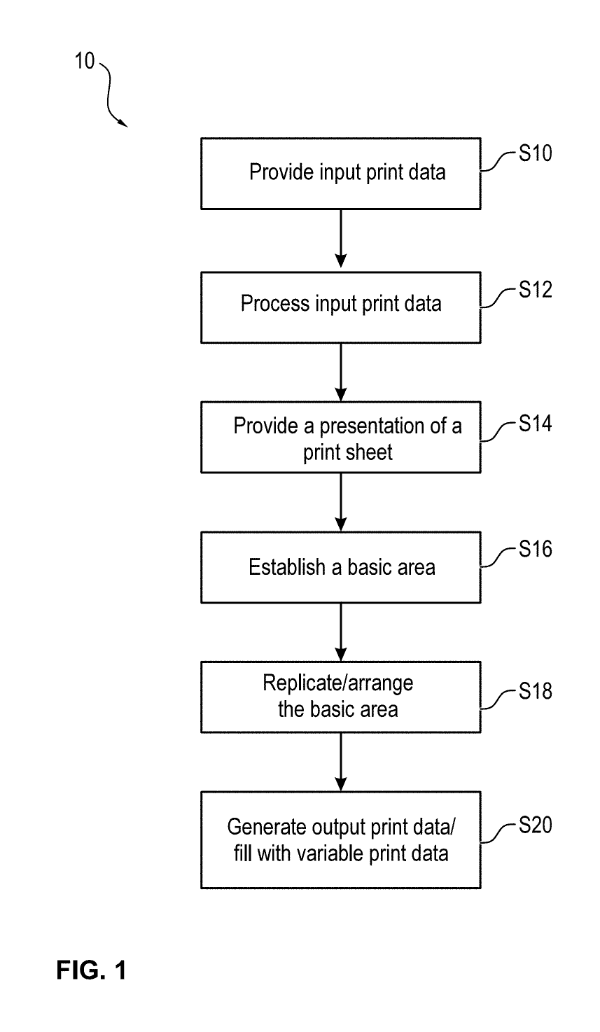

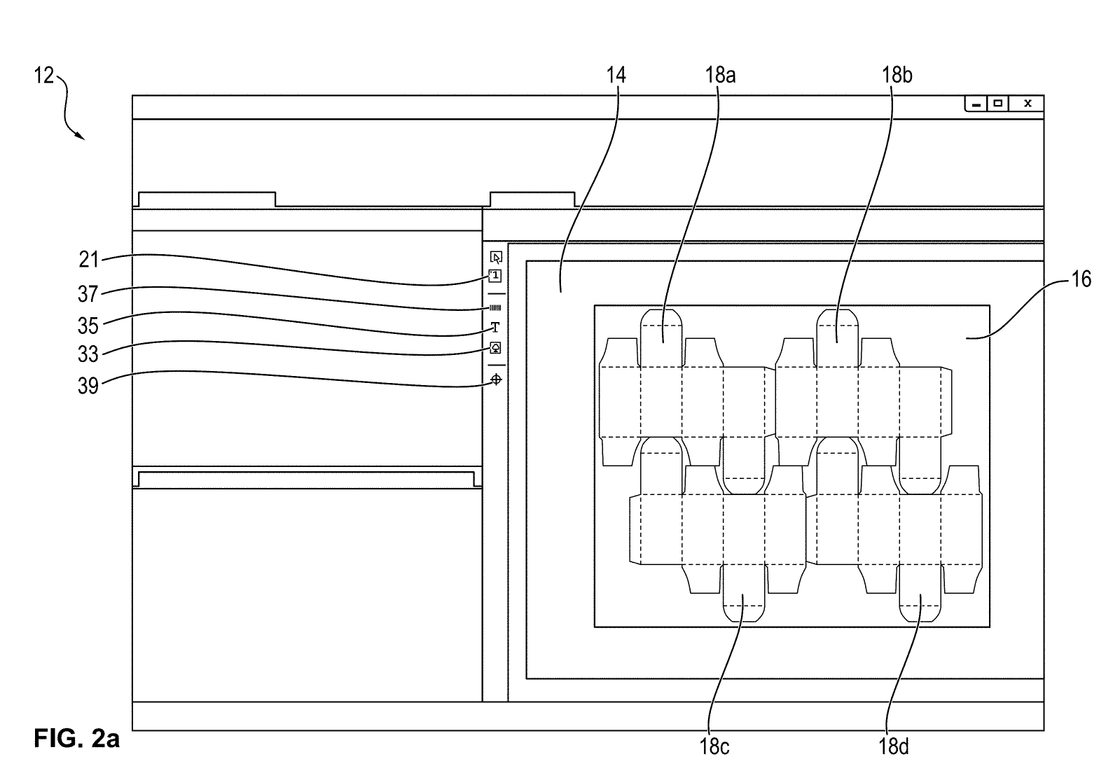

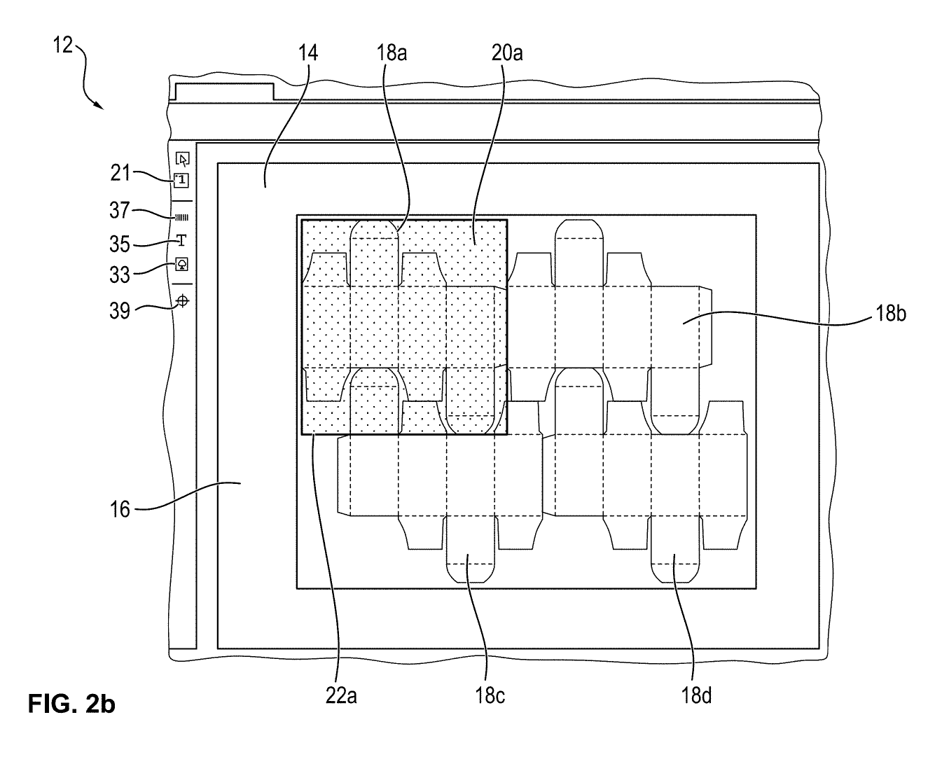

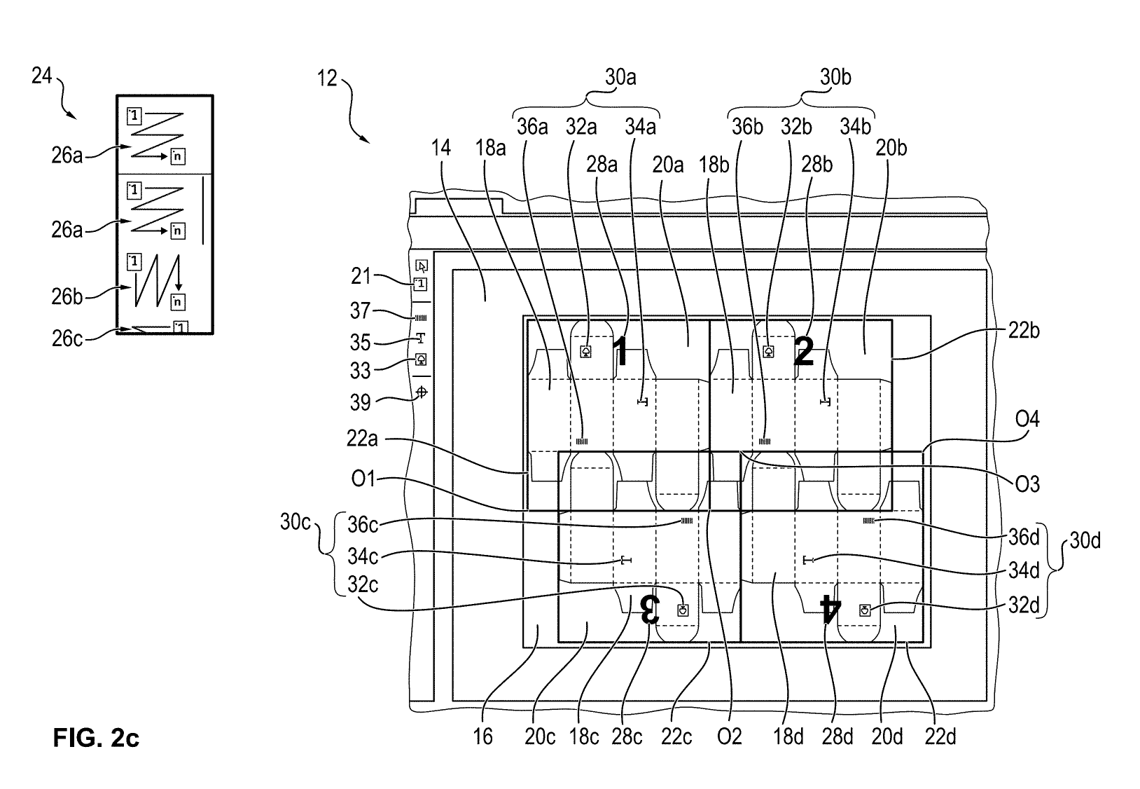

FIG. 1 shows a method 10 for the generation of output print data for the printing of multiple copies with at least one variable element on a print sheet according to an exemplary embodiment of the present disclosure. In an exemplary embodiment, the method 10 includes the following operations. In operation S10, input print data are provided for the printing of multiple copies with at least one variable element. In operation S12, the input print data are processed to present the print sheet with the multiple copies. In operation S14, a presentation of the print sheet in a workspace of a graphical user interface is provided. The presented print sheet thereby includes multiple copies arranged in a predetermined grid. In operation S16, a basic area is established in which at least one object is arranged for the generation of the variable element. The position of the object relative to the basic area is thereby established. The basic area also includes precisely one copy. In operation S18, the basic area with the at least one object is replicated and arranged according to the predetermined grid of the copies. In operation S20, the output print data for printing the copies with the at least one variable element are generated in that the replicated objects for generation of the variable elements are filled with variable print data. In an exemplary embodiment, the replication and arrangement of the basic area with the at least one object takes place automatically. More details of the method 10 are explained in the following using FIGS. 2a through 2c.

FIG. 2a shows a graphical user interface (GUI) 12 according to an exemplary embodiment of the present disclosure. The GUI 12 can include a workspace 14 for the illustration of a presented print sheet 16 having multiple copies 18a through 18d arranged in a predetermined grid. The presented print sheet 16 is obtained with the aid of operations S10 through S14 of the method 10 according to FIG. 1.

FIG. 2b shows the workspace 14 of the graphical user interface 12 according to FIG. 2a for the illustration of the establishment of a basic area 20a in operation S16 of the method according to FIG. 1. The basic area 20a is also designated as a master area. Operation S16 is executed with the aid of the icon 21. As shown in FIG. 2b, in an exemplary embodiment, the basic area 20a includes the copy 18a and segments of copy 18c. In FIG. 2b, it is also shown that the basic area 20a is defined by a frame 22a. The basic area 20a can be shifted and/or rotated relative to its copy 18a.

FIG. 2c shows the workspace 14 of the graphical user interface 12 according to FIG. 2a for the illustration of the replication and arrangement of the basic area 20a in operation S18 of the method 10 according to FIG. 1. Operation S18 is executed with the aid of a repetition rule. The repetition rule is predetermined with the aid of a menu 24. This serves to create what is known as the “repetition matrix”. In an exemplary embodiment, the menu 24 includes multiple selectable, preset stored patterns 26a through 26c for the provision of the repetition rule. In an exemplary embodiment, the repetition rule specifies an individual association of the replicated objects with the individual copies 18a through 18d of the print sheet 16. For example, an individual association of a consecutive number 28a through 28d of the replicated basic areas 20a through 20d with the copies 18a through 18d of the print sheet 16 respectively takes place with the aid of the selectable pattern 26a through 26c. In an exemplary embodiment, the selectable patterns 26a through 26c represent various zigzag patterns with the aid of which the respective incorporation of the consecutive numbers 28a through 28d is defined in the individual copies 18a through 18d of the print sheet 16. Furthermore, the incorporation of the consecutive numbers into the individual copies of multiple consecutive, continuous print sheets may also be defined with the aid of the selectable patterns 26a through 26c.

Shown in FIG. 2c is a group 30a of objects 32a, 34a, 36a for the generation of variable elements, which group 30a is arranged in the basic area 20a. The positions of the objects 32a, 34a, 36a of the group 30a are respectively established relative to the basic area 20a. This in particular takes place in operation S16. The objects 32a, 34a, 36a of the group 30a are generated with the aid of corresponding icons 33, 35, 37. In particular, the positions of the objects 32a, 34a, 36a of the group 30a are respectively defined relative to a coordinate origin O1 of the basic area 20a.

In operation S18, the replicated objects 32a through 32d, 34a through 34d, 36a through 36d of the replicated groups 30a through 30d are always arranged at an identical position relative to a coordinate origin O1 through O4 of the respective associated basic area 20a through 20d. In operation S18, the replicated basic areas 20a through 20d are also generated such that they are arranged in a grid that corresponds to the grid of the copies 18a through 18d. This means that the basic areas 20a through 20d that are defined by the frames 22a through 22d respectively include precisely one copy 18a through 18d.

In operation S18, each basic area 20a through 20d is respectively individually shifted and/or rotated relative to its copy 18a through 18d. In an embodiment, this takes place automatically. Furthermore, the basic areas 20a through 20d may also be manually shifted and/or rotated. The basic areas 20a through 20d may thereby be very precisely brought into agreement with the grid of copies 18a through 18d.

With regard to FIG. 2c, upon rotating the basic areas 20a through 20d, the respective coordinate origin O1 through O4 rotates as well. This is clarified by way of example using the coordinate origins O3, O4 of the basic areas 20c, 20d.

The replicated objects 32a through 32d, 34a through 34d, 36a through 36d of the groups 30a through 30d respectively serve to generate the variable elements that should be printed on the print sheets 16. This in particular takes place in operation S20. In an exemplary embodiment, the variable elements to be printed respectively include a barcode element, a text element or a graphic element. In an exemplary embodiment, the variable elements are also respectively provided by an external data source and/or taken from an internal counter or a job ticket.

Optionally, an icon 39 is provided with the aid of which a marker may be generated as a positioning aid for the arrangement of the objects 32a through 32d, 34a through 34d, 36a through 36d of the groups 30a through 30d in the basic areas 20a through 20d.

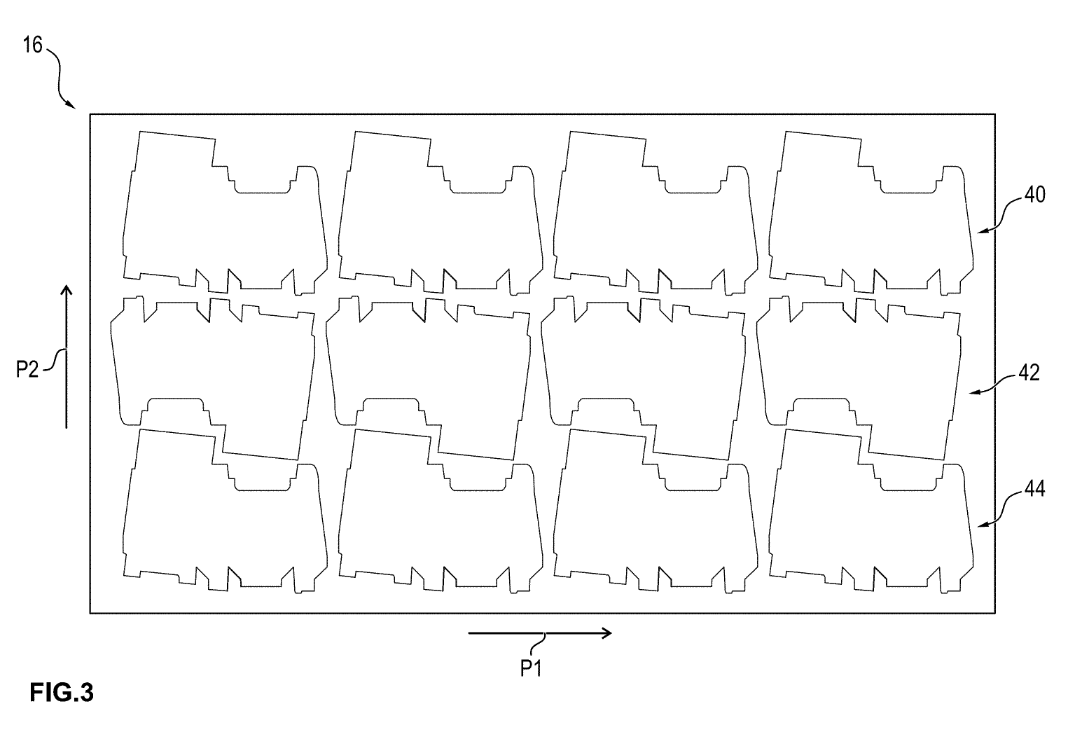

FIG. 3 shows an example of a print sheet 16 having multiple lines 40, 42, 44 of copies arranged in superposition to produce multiple folded boxes according to an exemplary embodiment of the present disclosure. As shown in FIG. 3, the copies of lines 42 and 44 overlap at least in part in the vertical direction. The copies of lines 42 and 44 are also arranged offset from one another in the horizontal direction. The horizontal direction is depicted by the arrow P2 in FIG. 3, whereas the vertical direction is depicted by the arrow P2 in FIG. 3. In particular, the copies of the middle line 42 in FIG. 4 are rotated by 180° relative to the copies of the upper and lower line 40, 44. The copies of the lines 40, 42, 44 of the print sheet 16 may be provided as input print data in operation S10. The print sheet 16 shown in FIG. 3 in particular includes 12 copies for the production of 12 folded boxes. The print sheet 16 shown in FIG. 3 is also characterized by a comparably high utilization rate.

In particular, in method 10 the print sheets may be used for the production of folded boxes as they are sent from the workflow to the PRISMAproduction system.

In the present disclosure, print data that are considered to be “finished” (PDF files, for example) may also be provided afterwards—thus still before the actual printing process onto paper—with variable contents in the form of barcode, text or images and graphics, in order to increase the added value of the end products. For particular tasks, multiple copies of the same printed matter may be distributed in a more or less uniform pattern on a large print sheet. The copies hereby do not necessarily need to be arranged end-to-end, but rather may be slid into one another and rotated in order to achieve the maximum number of copies on a print sheet, for example as in the example of folded boxes. In contrast to the prior art, in this instance the present disclosure even enables the targeted and effective placement of individual variable elements on the print sheet.

An advantage of the exemplary embodiments of the present disclosure is that elements having variable contents that continue consecutively from copy to copy, further on to the next print sheet, may be placed on any individual copy of the print sheet. The contents may be taken from an external data source (for example an XML, CSV file or database) and/or from an internal counter, job ticket etc. Depending on the data source, many print sheets may be created that show the same motif but differ in variable elements.

According to one or more exemplary embodiments of the present disclosure, for this the pattern of the distribution of the copies may be based on the print sheet (layout) to ensure an exact positioning of the variable elements on each copy.

Optionally, it is similarly possible to finish analogous print data (i.e. papers that have already been pre-printed) with variable elements.

With the aid of the exemplary embodiments of the present disclosure, it is possible to very efficiently and exactly bring variable print data to a print-ready or already printed print sheet. An exemplary embodiment of the software is essentially comprised of a workspace in which the print sheet to be finished is displayed and tools that enable the creation and placement of the variable elements.

The basic principle provides that the individual variable elements (such as barcode, text, images and graphics) are combined into what is known as a Master Content Group 20a, and this group (which is visually represented by a frame 22a) is subsequently distributed or replicated in copies, automatically or manually, corresponding to the grid of copies on the print sheet. Individual shifts and rotations of the frame are possible. Complex and irregular layouts may thus also be realized. The variable contents enter into the grid according to a definable pattern, beginning with the Master Content Group (copy 1).

The order of the copies (i.e. the zigzag pattern 26a through 26c) may thereby be modified. By double-clicking on the numbers 28a through 28d that are associated with the respective copy, an input row opens in which a different number may be input. Reasonably, only an already existing number may be input on the print sheet. The newly input number and the previous number are then exchanged. Specific contents may thus be applied to specific copies in a targeted manner.

The method according to an exemplary embodiment of the present disclosure includes the following operations:
creation of the “Master Content Group”
creation of the “Repetition Matrix”
placement and positioning of the variable elements
determination of the contents of the variable elements

In an exemplary embodiment, as resources, the workspace of the graphical user interface includes, for example, rulers, auxiliary lines, background grids, zoom in, zoom out, marking and displacement of the objects using, for example, a mouse, keyboard and direct input of the values, a tool to align on object edges, and a preview of the print sheet with its new variable contents.

In an exemplary embodiment, there can be two creation scenarios. It is thereby a precondition that the document to be processed is automatically loaded at the start of the program or dialog and is displayed in the preview.

In an exemplary embodiment, the first scenario includes the following operations:
creation of the “Master Content Group”
creation of the “Repetition Matrix”
placement and positioning of the variable elements
determination of the contents of the variable elements

In an exemplary embodiment, the second scenario includes the following operations:
creation of the “Master Content Group”
placement and positioning of the variable elements
creation of the “Repetition Matrix”
determination of the contents of the variable elements

As soon as the “Master Content Group” has been defined, additional creation variations are possible.

Exemplary embodiments of the present disclosure enable a simple, clear and retroactive finishing of print data with variable elements with a few clear operations; a preview of the entire print sheet including the finishing objects; variant-rich creation sequences and modes of operation for the user; a visual, interactive and flexible reworking or modification/adaptation of positions and contents; as well as a visual monitoring of each work operation. The possibility also exists to store the work as a template for a later or automatic reuse.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

### REFERENCE LIST

10 method
12 graphical user interface
14 workspace
16 print sheet
18a to 18d copies
20a to 20d basic area
21, 33, 35,
37, 39 icon
22a to 22d frame of the basic area
24 menu
26a to 26c pattern
28a to 28d consecutive number
30a to 30d group of objects
32a to 32d,
34a to 34d,
36a to 36d object
O1 to O4 coordinate origin
P1, P2 direction
40 to 44 line of copies
S10 to S20 operation

What is claimed is:

1. A method for generating output print data for printing multiple copies with at least one variable element on a print sheet, the method comprising:
providing input print data with at least one variable element for printing of multiple copies;
processing the input print data to present the print sheet with the multiple copies;
providing a presentation of the print sheet in a workspace of a graphical user interface, wherein the presented print sheet includes multiple copies arranged in a predetermined grid,
establishing a basic area in which at least one object for generation of the at least one variable element is arranged, wherein a position of the at least one object is established relative to the basic area, and wherein the basic area includes precisely one copy;
replicating and arranging the basic area having the at least one object according to the predetermined grid of the multiple copies; and
generating output print data for printing of the multiple copies with the at least one variable element, wherein the replicated objects are filled with variable print data to generate the at least one variable element.

2. The method according to claim 1, wherein the replication of the basic area with the at least one object is performed automatically.

3. The method according to claim 1, wherein the replication of the basic area with the at least one object is performed with the aid of a repetition rule.

4. The method according to claim 3, wherein the repetition rule specifies an individual association of the replicated objects with the individual copies of the print sheet.

5. The method according to claim 1, wherein:
the basic area is defined by a frame, and
the basic area can be shifted and/or rotated relative to its copy.

6. The method according to claim 5, wherein, given replication of the basic area having the at least one object, the replicated objects are arranged at an identical position relative to a coordinate origin of the respective associated basic area.

7. The method according to claim 1, wherein, given replication of the basic area having the at least one object, each basic area can be individually shifted and/or rotated so that each basic area is arranged respectively according to the predetermined raster of the copies after the shifting and/or rotation.

8. The method according to claim 1, wherein:
upon establishment of the basic area, a group of objects for generation of the at least one variable element is arranged in the basic area, and
the positions of the objects of the group are respectively established relative to the basic area.

9. The method according to claim 1, wherein:
the at least one variable element comprises a barcode element, a text element or an image element, and
the at least one variable element is provided by an external data source and/or is taken from an internal counter or a job ticket.

10. A computer program product comprising commands and data in coded form that, after the loading of the program data, induce a processor to execute the operations of the method according to claim 1.

11. A printing system configured to perform the method according to claim 1.

12. A method for generating output print data for printing multiple copies with at least one variable element on a print sheet, the method comprising:
providing input print data with at least one variable element for printing of multiple copies;
processing the input print data to present the print sheet with the multiple copies;
providing a presentation of the print sheet in a workspace of a graphical user interface, wherein the presented print sheet includes multiple copies arranged in a predetermined grid,
establishing a basic area in which at least one object for generation of the at least one variable element is arranged, wherein a position of the at least one object is established relative to the basic area, the basic area including a copy;
replicating and arranging the basic area having the at least one object based on the predetermined grid of the multiple copies; and
generating output print data for printing of the multiple copies with the at least one variable element, wherein the replicated objects are filled with variable print data to generate the at least one variable element.
